(19) United States
(12) Patent Application Publication
(10) Pub. No.: US 2012/0314419 A1
(43) Pub. Date: Dec. 13, 2012

(54) Heat dissipation structure of light-emitting diode

(76) Inventor: Wen-Kung Sung, Taiepi City (TW)

(21) Appl. No.: 13/067,538

(22) Filed: Jun. 8, 2011

(51) Int. Cl. F21V 29/00

(52) U.S. Cl. 362/294; 362/373

(57) ABSTRACT

A heat dissipation structure of light-emitting diode includes a package housing, which forms a recessed cavity. A heat dissipation frame is mounted inside the recessed cavity of the package housing to have a portion of the heat dissipation frame located inside the recessed cavity of the package housing and opposite ends of the heat dissipation frame being bent downward to overlap a bottom surface of the heat dissipation frame. A plurality of light-emitting chips is set on the heat dissipation frame located inside the recessed cavity. A plurality of conductive pins is arranged in the recessed cavity of the package housing and extends outside opposite ends of the package housing through opposite end walls of the recessed cavity. A plurality of conductive wires respectively connects between the light-emitting chips and the conductive pins inside the recessed cavity to thereby form the heat dissipation structure of light-emitting diode.

### FIELD OF THE INVENTION

The present invention relates to a heat dissipation structure of light-emitting diode, and in particular to a heat dissipation structure of light-emitting diode that comprises a heat dissipation frame mounted inside a package housing and having two ends that are downward bent to overlap a bottom surface of the heat dissipation frame.

### BACKGROUND OF THE INVENTION

A variety of light-emitting diode (LED) based lighting devices are available in the market. A common issue for these lighting devices is large amount of heat generated by the LED. The heat must be dissipated from the LED lighting devices. A major research direction of the LED industry is to eliminate excessive high temperature that might shorten the lifespan of the devices.

Two major types of constructions are currently used for LED lighting devices, which will be briefly described as follows:

(1) A heat sink is arranged between the LED lighting device and a circuit board so that the heat generated by the LED lighting device can be efficiently dissipated through engagement between conductive pins of the LED lighting device and the heat sink.

(2) The conductive pins of an LED lighting device are of a thickness of around 0.4 mm. To help bending the conductive pins, a stamping or scraping operation may be performed to reduce the 0.4 mm thickness of the conductive pins, whereby the conductive pins are stamped or scraped to exhibit a thickness of around 0.2 mm, which allows of easy bending of the conductive pins.

These two ways suffer certain disadvantages that must be further improved. For the way of additionally mounting a heat sink, the heat sink increases the cost and the heat sink must be properly processed before the heat sink and the LED lighting device can be combined together. An additional process is required and this extends the manufacturing time. Further, for the way of stamping or scraping the conductive pins, the processing expense is high and the additional operation used to process the thickness of the conductive pins may be difficult to stamp or scrape the conductive pins to a small thickness. This in turn extends the manufacturing time and increases the manufacturing cost.

Apparently, the conventional ways are both disadvantageous in certain respects and further improvement is desired.

In view of the above discussed drawbacks, the present invention aims to provide a heat dissipation structure of light-emitting diode, which will be further described in the following.

### SUMMARY OF THE INVENTION

The primary objective of the present invention is to mount a heat dissipation frame to a package housing to allow a light-emitting chip that generates high temperature to be mounted on the heat dissipation frame. Opposite ends of the heat dissipation frame are bent downward to overlap a bottom surface of the heat dissipation frame, whereby when the light-emitting diode according to the present invention is mounted to a circuit board that is coupled with a heat dissipater, since the light-emitting chip is set in tight engagement with the heat dissipation frame, the high temperature generated by the light-emitting diode can be conducted to the heat dissipation frame and then to the heat dissipater for dissipation. The heat dissipation route is thus made a direct and shortest way, providing an enhanced heat dissipation performance for the high temperature generated by the light-emitting chip.

A secondary objective of the present invention is to provide a heat dissipation frame that is made through a single stamping operation applied to a single piece of raw material, whereby the constituent material is identical and the thickness is the same and is thus applicable to simultaneous stamping with all types of stamping machines that are currently available (such as a stamping press). Since a single piece of raw material is used, the amount of scrap can be reduced, making cost and consumption of material minimum and complying with the trend of environmental protection and simplifying and shortening the manufacturing process.

A further objective of the present invention is to provide various advantages of mass production and fast manufacturing through practicing an embodiment of the present invention.

Yet a further objective of the present invention is to provide an optimum way of heat dissipation through omission of additional heat dissipation element and eliminating mutual interference due to heat and electricity are separated.

To achieve the above objective, the present invention provides a heat dissipation structure of light-emitting diode, which comprises: a package housing, a heat dissipation frame, a plurality of light-emitting chips, a plurality of conductive pins, and a plurality of conductive wires. The package housing forms a recessed cavity. The heat dissipation frame is mounted inside the recessed cavity of the package housing to have a portion of the heat dissipation frame located inside the recessed cavity of the package housing and opposite ends of the heat dissipation frame being bent downward to overlap a bottom surface of the heat dissipation frame. The plurality of light-emitting chips is set on the heat dissipation frame located inside the recessed cavity. The plurality of conductive pins is arranged in the recessed cavity of the package housing and extends outside opposite ends of the package housing through opposite end walls of the recessed cavity. The plurality of conductive wires respectively connects between the light-emitting chips and the conductive pins inside the recessed cavity to thereby form the heat dissipation structure of light-emitting diode.

### BRIEF DESCRIPTION OF THE DRAWINGS

The present invention will be apparent to those skilled in the art by reading the following description of preferred embodiments thereof with reference to the drawings, in which:

FIG. 1 is a perspective view of a heat dissipation structure of light-emitting diode according to the present invention;

FIG. 2 is a top plan view of the heat dissipation structure of light-emitting diode according to the present invention;

FIG. 3 a side elevational view of the heat dissipation structure of light-emitting diode according to the present invention;

FIGS. 4A and 4B are schematic views illustrating bending of ends of a heat dissipation frame of the heat dissipation structure of light-emitting diode according to the present invention;

FIGS. 5A and 5B are schematic views illustrating applications of the heat dissipation structure of light-emitting diode according to the present invention; and

FIG. 6 is a schematic view illustrating a light-transmitting body mounted to the heat dissipation structure of light-emitting diode according to the present invention.

### DETAILED DESCRIPTION OF THE PREFERRED EMBODIMENTS

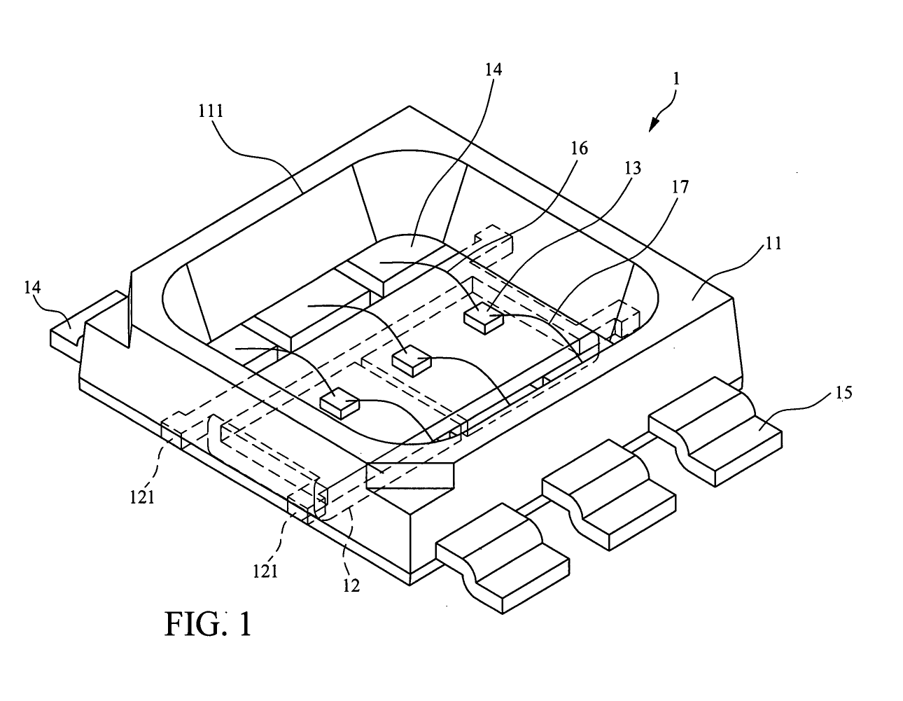

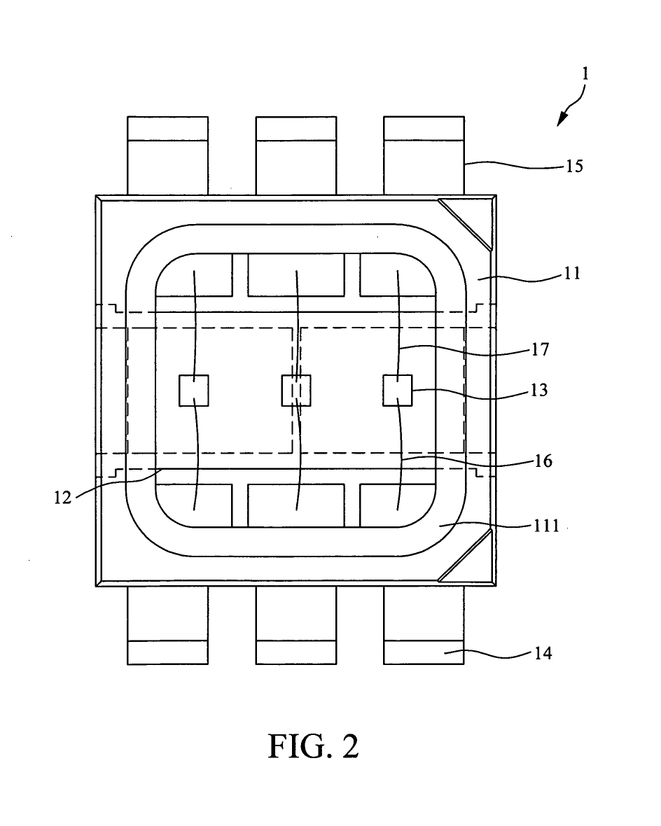

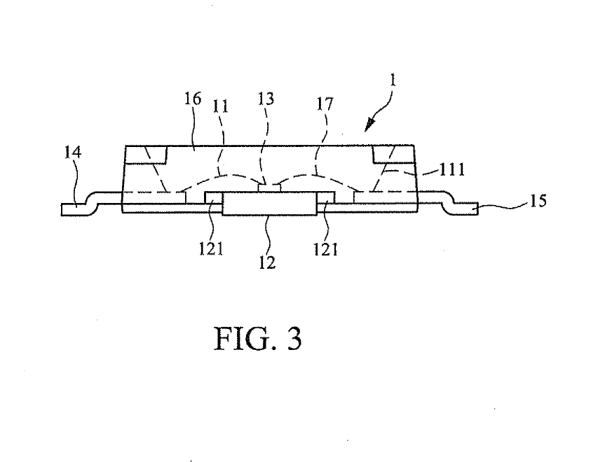

With reference to the drawings and in particular to FIGS. 1-3, which are different views of a heat dissipation structure of light-emitting diode according to the present invention, the light-emitting diode, generally designated at 1, comprises the following components:

A package housing 11 forms a recessed cavity 111.

At least one heat dissipation frame 12 is mounted in the recessed cavity 111 of the package housing 11 to have a portion thereof located inside the recessed cavity 111 of the package housing 11 and opposite ends of the heat dissipation frame 12 being bent downward to overlap a bottom surface of the heat dissipation frame 12, whereby the ends of the heat dissipation frame 12 are bent inward to a bottom surface of the package housing 11.

At least one light-emitting chip 13 is positioned on a desired location on the portion of the heat dissipation frame 12 inside the recessed cavity 111 of the package housing 11.

At least one first conductive pin 14 has an end extending through an end wall from inside the recessed cavity 111 to outside the package housing 11.

At least one second conductive pin 15 has an end extending through an opposite end wall from inside the recessed cavity 111 to outside the package housing 11.

At least one first conductive wire 16 has an end connected to the light-emitting chip 13 and an opposite end connected to the first conductive pin 14.

At least one second conductive wire 17 has an end connected to the light-emitting chip 13 and an opposite end connected to the second conductive pin 15.

With an assembly composed of the above constituent components, the heat dissipation structure of light-emitting diode according to the present invention is formed.

The heat dissipation frame 12 is preferably made of a material of metal or metallic alloy.

The first conductive wire 16 applies negative electrical polarity from the first conductive pin 14 to the light-emitting chip 13. The second conductive wire 17 is connected to the light-emitting chip 13 and is also connected to the second conductive pin 15 located inside the recessed cavity 111, so that the second conductive wire 17 applies positive electrical polarity from the second conductive pin 15 to the light-emitting chip 13.

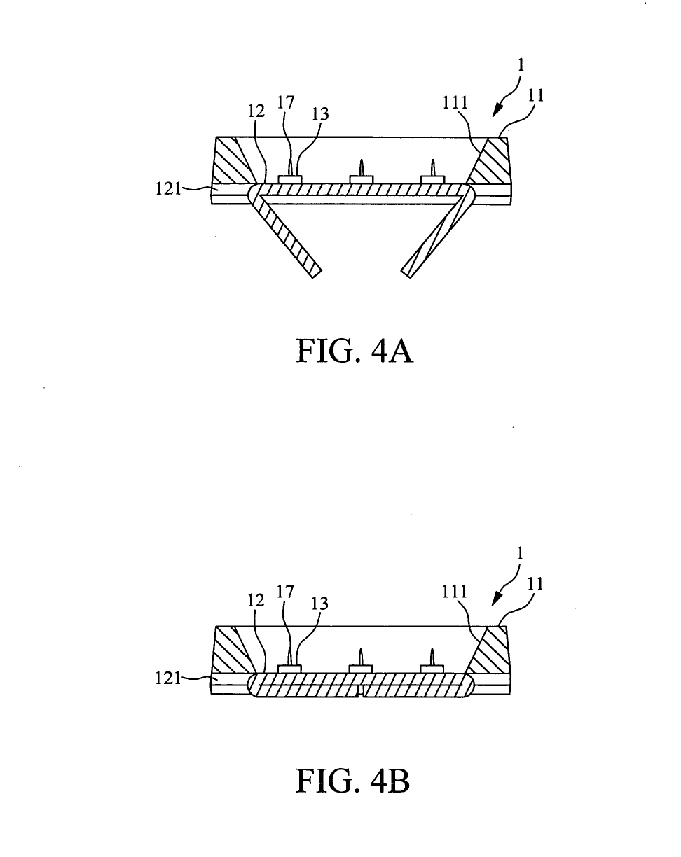

Referring to FIGS. 4A and 4B, which are schematic views illustrating an operation of bending the ends of the heat dissipation frame of the heat dissipation structure of light-emitting diode to an overlapping condition, the heat dissipation frame 12 is processed through stamping the opposite ends of the heat dissipation frame 12 to have the ends of the heat dissipation frame 12 bent downward to overlap the bottom surface of the heat dissipation frame 12, whereby when the heat dissipation frame 12 is mounted inside the recessed cavity 111 of the package housing 11, opposite side portions of each end of the heat dissipation frame 12 that are not subjected to stamping forms two support legs 121, and the side support legs 121 extend outward of the package housing 11. An operation of trimming may be employed to cut off the portions of the support legs 121 of the two sides that project beyond the ends of the package housing 11, making them substantially flush with the ends of the package housing 11. As such, the operation of bending, overlapping, and trimming of the heat dissipation frame 12.

Through bending and overlapping of the two ends of the heat dissipation frame 12 under the bottom surface of the heat dissipation frame 12, a heat dissipation route having the shortest distance is realized, which makes a significant improvement on the efficiency of heat dissipation.

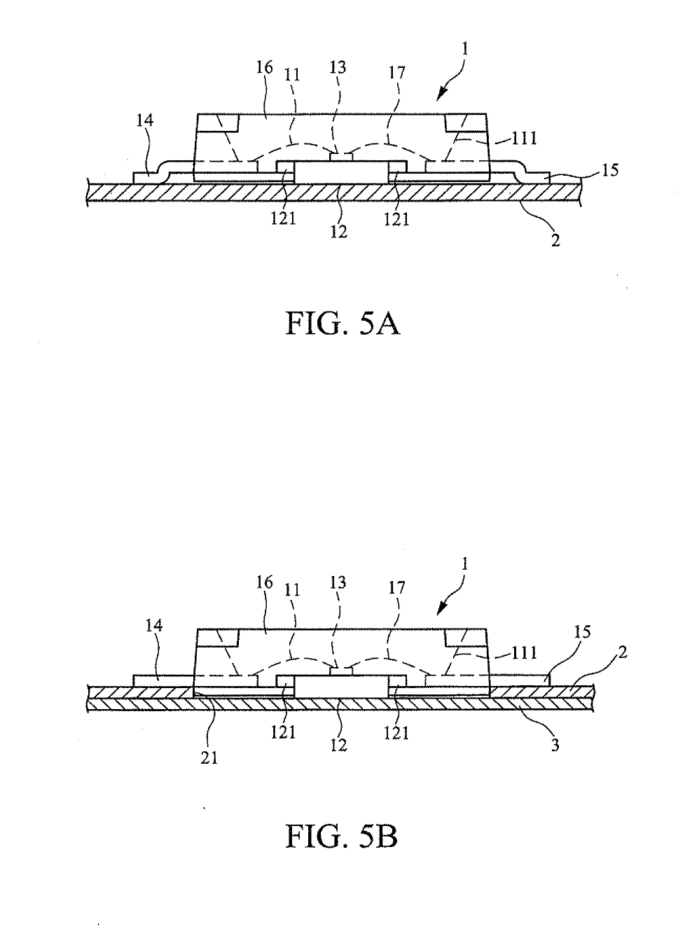

Referring to FIGS. 5A and 5B, which are schematic views illustrating applications of the heat dissipation structure of light-emitting diode according to the present invention, the light-emitting diode 1 according to the present invention is positionable on a circuit board 2 (see FIG. 5A) with the end of the first conductive pin 14 and the end of the second conductive pin 15 that are located outside the package housing 11 bonded, through for example soldering, to the circuit board 2. In this way, since the heat dissipation frame 12 located on the bottom surface of the package housing 11 forms a face-to-face contact engagement with the circuit board 2, the heat and high temperature generated by the light-emitting diode 1 can be conducted away and thus dissipated to maintain the light-emitting diode 1 at the optimum condition of operation. As shown in FIG. 5B, a circuit board 2 is mounted on a heat dissipater 3. The circuit board 2 forms at least one receiving opening 21, whereby the light-emitting diode 1 is received in the receiving opening 21 of the circuit board 2. The light-emitting chip 13 is set in tight engagement with the heat dissipation frame 12, whereby the high temperature generated by the light-emitting diode 1 is conducted to the heat dissipation frame 12 and the to the heat dissipater 3 for dissipation. Since the distance from the light-emitting chip 13 to the heat dissipater 3 is extremely short, the heat dissipation route is made a direct and shortest way, providing the present invention with the optimum result of heat dissipation.

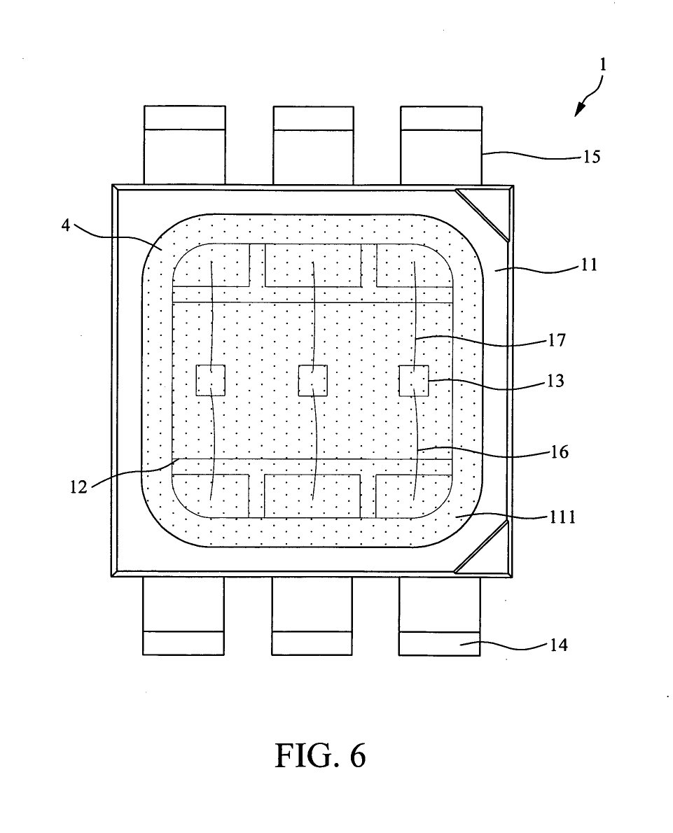

Referring to FIG. 6, which is a schematic view illustrating a light-transmitting body mounted to the heat dissipation structure of light-emitting diode according to the present invention, the recessed cavity 111 of the package housing 11 can receive a light-transmitting body 4 to fill therein so that the body is formed inside the recessed cavity 111. The light-transmitting body 4 is formed by filling a melting light-transmitting plastic material into the recessed cavity 111 and then allowing the plastic material to cure for packaging the heat dissipation frame 12, the light-emitting chip 13, the first conductive pin 14, the second conductive pin 15, the first conductive wire 16, and the second conductive wire 17 inside the recessed cavity 111.

The light-transmitting material 4 may contain therein fluorescent powders, whereby when the light-emitting chip 13 emits light, the light is converted by the fluorescent powders into different wavelengths to thereby give off lights of different colors.

Thus, based on the embodiment of the present invention, advantages of mass production and fast manufacturing can be realized. Further, since the additional heat dissipation element can be omitted, an optimum way of heat dissipation is provided. Further, due to heat and electricity are separated, there will be no mutual interference. Further, excessive scrap can be reduced, making cost and consumption of material minimum and complying with the trend of energy saving, carbon reduction, and environmental protection. Further, the manufacturing process can be simplified and shortened. All these make the present invention advantageous in diverse benefits.

Although the present invention has been described with reference to the preferred embodiments thereof, it is apparent to those skilled in the art that a variety of modifications and changes may be made without departing from the scope of the present invention which is intended to be defined by the appended claims.

1. A heat dissipation structure of light-emitting diode, comprising:
a package housing, which forms a recessed cavity;
at least one heat dissipation frame, which is mounted in the recessed cavity of the package housing to have a portion thereof located inside the recessed cavity of the package housing, the heat dissipation frame having opposite ends that are bent downward to overlap a bottom surface of the heat dissipation frame;
at least one light-emitting chip, which is positioned on a predetermined location on a portion of the heat dissipation frame inside the recessed cavity of the package housing;
at least one first conductive pin, which has an end extending through an end wail from inside the recessed cavity to outside the package housing;
at least one second conductive pin, which has an end extending through an opposite end wall from inside the recessed cavity to outside the package housing;
at least one first conductive wire, which has an end connected to the light-emitting chip and an opposite end connected to the first conductive pin; and
at least one second conductive wire, which has an end connected to the light-emitting chip and an opposite end connected to the second conductive pin.

2. The heat dissipation structure of light-emitting diode as claimed in claim 1, wherein the heat dissipation frame is made of metal.

3. The heat dissipation structure of light-emitting diode as claimed in claim 1, wherein the heat dissipation frame is made of metal alloy.

4. The heat dissipation structure of light-emitting diode as claimed in claim 1, wherein the first conductive wire applies negative electrical polarity from the first conductive pin to the light-emitting chip, the second conductive wire being connected to the light-emitting chip and the second conductive pin located inside the recessed cavity, so that the second conductive wire applies positive electrical polarity from the second conductive pin to the light-emitting chip.

5. The heat dissipation structure of light-emitting diode as claimed in claim 1, wherein the recessed cavity of the package housing receives a light-transmitting body filled therein to package the heat dissipation frame, the light-emitting chip, the first conductive pin, the second conductive pin, the first conductive wire, and the second conductive wire inside the recessed cavity.

6. The heat dissipation structure of light-emitting diode as claimed in claim 5, wherein the light-transmitting body is formed of a melting light-transmitting plastic material that is filled into and cured inside the recessed cavity.

7. A heat dissipation structure of light-emitting diode, comprising:
a package housing, which forms a recessed cavity;
at least one heat dissipation frame, which is mounted in the recessed cavity of the package housing to have a portion thereof located inside the recessed cavity of the package housing, the heat dissipation frame having opposite ends that are bent downward to overlap contiguously a bottom surface of the heat dissipation frame;
at least one light-emitting chip, which is positioned on a predetermined location on a portion of the heat dissipation frame inside the recessed cavity of the package housing;
at least one first conductive pin, which has an end extending through an end wall from inside the recessed cavity to outside the package housing;
at least one second conductive pin, which has an end extending through an opposite end wall from inside the recessed cavity to outside the package housing;
at least one first conductive wire, which has an end connected to the light-emitting chip and an opposite end connected to the first conductive pin; and
at least one second conductive wire, which has an end connected to the light-emitting chip and an opposite end connected to the second conductive pin.

8. The heat dissipation structure of light-emitting diode as claimed in claim 7, wherein the heat dissipation frame is made of metal.

9. The heat dissipation structure of light-emitting diode as claimed in claim 7, wherein the heat dissipation frame is made of metal alloy.

10. The heat dissipation structure of light-emitting diode as claimed in claim 7, wherein the first conductive wire applies negative electrical polarity from the first conductive pin to the light-emitting chip, the second conductive wire being connected to the light-emitting chip and the second conductive pin located inside the recessed cavity, so that the second conductive wire applies positive electrical polarity from the second conductive pin to the light-emitting chip.

11. The heat dissipation structure of light-emitting diode as claimed in claim 7, wherein the recessed cavity of the package housing receives a light-transmitting body filled therein to package the heat dissipation frame, the light-emitting chip, the first conductive pin, the second conductive pin, the first conductive wire, and the second conductive wire inside the recessed cavity.

12. The heat dissipation structure of light-emitting diode as claimed in claim 11, wherein the light-transmitting body is formed of a melting light-transmitting plastic material that is filled into and cured inside the recessed cavity.
